(19) United States
(12) Patent Application Publication
(10) Pub. No.: US 2010/0035223 A1
(43) Pub. Date: Feb. 11, 2010

(54) Medical training apparatus

(75) Inventors: Naotake Shibui, Chiyoda-ku (JP); Satoshi Uzuka, Chiyoda-ku (JP); Wataru Miyashita, Chiyoda-ku (JP); Hitoshi Akiyama, Chiyoda-ku (JP); Setsuhiro Hara, Chiyoda-ku (JP); Kazuo Nishikawa, Kyoto-shi (JP); Mikinori Nishimura, Kyoto-shi (JP); Yukihiko Isokawa, Kyoto-shi (JP)

Correspondence Address: Quinn Emanuel Urquhart Oliver & Hedges LLP;Koda/Androlia, 10th Floor, 865 S. Figueroa Street, Los Angeles, CA, 90017, US

(73) Assignee: J. Morita Manufacturing Corporation

(21) Appl. No.: 12/460,995

(22) Filed: Jul. 27, 2009

(30) Foreign Application Priority Data
Jul. 30, 2008 (JP) 2008-196023
Jul. 3, 2009 (JP) 2009-158567

(51) Int. Cl. G09B 23/28

(52) U.S. Cl. 434/263

(57) ABSTRACT

A medical training apparatus that is capable of recording a training history based on a medical training scenario and storing an evaluation of training that corresponds to the training history is provided. The medical training apparatus includes a training-history-information storage unit, an evaluation input unit, an operation unit, and a training-evaluation-information storage unit. The training-history-information storage unit stores history information about a training session that has been performed under a preset medical training scenario. The evaluation input unit inputs an evaluation result for either the training session or the history information stored in the training-history-information storage unit, with respect to a predetermined evaluation item for each predetermined matter. The operation unit performs an arithmetic operation on the evaluation result that has been input with the evaluation input unit. The training-evaluation-information storage unit stores the result of operation unit and the evaluation result in association with the history information.

### BACKGROUND OF THE INVENTION

1. Field of the Invention

The present invention relates to a medical training apparatus and in particular to a medical training apparatus with which training is performed under a medical training scenario.

2. Description of the Background Art

For the purpose of improving medical procedures performed by health care workers, various medical training apparatuses have been developed. For example, International Patent Publication No. WO2008/023464 (Patent Document 1) discloses a medical training apparatus that captures checking signals regarding an examination table or medical instruments and comprehends the contents of a medical procedure from those checking signals to output them as the reaction of a model patient, such as movements and/or facial expressions. The medical training apparatus disclosed in Patent Document 1 enables a trainee to sense the behavior of a model patient, such as facial expressions and/or movements, during the course of treatment. The medical training apparatus disclosed in Patent Document 1 includes a storage unit that stores checking signals that represent the conditions of medical instruments and the situation during consultation, and a training-result evaluation means that outputs an evaluation result based on previously stored criteria for evaluation; the storage unit and the training-result evaluation means enable proper correction and analysis of a medical procedure.

Japanese Patent Application Laid-Open No. 2007-185400 (Patent Document 2) discloses a medical training apparatus that includes a target body part on which a medical procedure is performed in a simulated setting, a soft material that is elastically deformable by a force acting on the perimeter of the target body part, a reflection type photointerrupter (sensor) that measures the state of a quantity that varies depending on the amount of deformation of the soft material, and a technique evaluation device that calculates an evaluation value for a technique for conducting a medical procedure from the measurement value obtained by the sensor, using an evaluation function parameter. The medical training apparatus disclosed in Patent Document 2 is capable of independently performing objective and quantitative evaluation of a technique for conducting a medical procedure.

### SUMMARY OF THE INVENTION

However, when medical training is performed under a medical training scenario in which movements and verbal communications during the course of a training session are described in a time sequence, the apparatuses disclosed in Patent Documents 1 and 2 do not store history information that has been associated with either the actions of a trainee who has performed the training or the records or the like of the training apparatus that have been stored at that time; it was thus difficult to review later on the relationship between a training session and its evaluation made at that time.

Trainees could not also review an evaluation that corresponds to each scene in their own training records, so that even if they reviewed their training records, it was not easy to grasp what part of the training session must be improved; such training records were thus not useful information.

An object of the present invention is to provide a medical training apparatus that is capable of recording a training history based on a medical training scenario and storing a training evaluation that corresponds to the training history.

In order to solve the above problems, a medical training apparatus according to a first aspect includes a training-history-information storage unit that stores history information about a training session that has been performed under a preset medical training scenario; an evaluation input unit that inputs an evaluation result for either the training session or the history information that has been stored in the training-history-information storage unit, with respect to a predetermined evaluation item for each predetermined matter; an operation unit that performs an arithmetic operation on the evaluation result that has been input with the evaluation input unit; and a training-evaluation-information storage unit that stores a result of the operation unit and the evaluation result in association with the history information.

With this apparatus, since the training-evaluation-information storage unit stores the result of the operation unit and the evaluation result in association with the history information, which evaluation result corresponds to which part of a training session is obvious. It is thus possible to review evaluation results after training and for a trainee to easily grasp what part of a training session must be improved. In addition, since the evaluation input unit is configured to input an evaluation result with respect to a predetermined evaluation item for each predetermined matter, it is possible to reduce variations in evaluation results from among those of each training or from among those of each evaluator and thereby to make an objective evaluation.

A medical training apparatus according to a second aspect further includes a display unit that displays at least any one of the history information, the result of the operation unit, and the evaluation result.

This apparatus enables the history information, the result of the operation unit, and the evaluation result to be checked with ease.

A medical training apparatus according to a third aspect further includes an image capturing unit that captures an image of the training session, wherein the training-history-information storage unit stores history information that includes an image of the training session that has been captured by the image capturing unit.

With this apparatus, the history information including visual information makes it easier to grasp a training session.

A medical training apparatus according to a fourth aspect includes the image capturing unit that is configured so as to be capable of capturing images of the training session from a plurality of angles.

With this apparatus, history information including diversified image information makes it easier to grasp a training session.

A medical training apparatus according to a fifth aspect further includes an imitation patient body including a drive unit that produces motion of at least a mouth and eyes, and a detection unit provided at a tooth in an oral cavity and/or a jaw; wherein the training-history-information storage unit stores history information that includes a drive history of the drive unit and a detection history of the detection unit.

This apparatus enables the condition of a patient to be obtained from the imitation patient body and to be stored as history information.

In a medical training apparatus according to a sixth aspect, the imitation patient body is configured so as to produce a facial expression or movement depending on the evaluation result.

This apparatus enables a trainee to perform training in a situation similar to actual medical practice.

In a medical training apparatus according to a seventh aspect, the imitation patient body is configured so as to vary a facial expression or movement by driving of the drive unit with an input unit.

This apparatus enables a trainee or an evaluator to train their decision-making or management skills when encountering an unexpected situation.

In a medical training apparatus according to an eighth aspect, the evaluation input unit is configured so as to be capable of inputting an evaluation result with respect to the predetermined evaluation item by selecting the predetermined evaluation item from among a plurality of preset options.

This apparatus enables a more objective evaluation of a training session and enables more quantitative and statistical processing of an evaluation result.

In a medical training apparatus according to a ninth aspect, the evaluation input unit is configured so as to be capable of inputting a comment for each evaluation result with respect to the predetermined evaluation item.

This apparatus enables an evaluator to store the point that he or she has noticed about a training session, in association with each evaluation item.

In a medical training apparatus according to a tenth aspect, the evaluation input unit includes a plurality of evaluation input units; and the operation unit is configured so as to perform predetermined statistical processing on a plurality of evaluation results that have been input with the evaluation input units.

With this apparatus, a plurality of evaluators can evaluate the training at the same time, and a variety of information can be obtained from a plurality of evaluation results that have been subjected to statistical processing.

In a medical training apparatus according to an eleventh aspect, the operation unit is configured so as to perform predetermined statistical processing that includes a process for determining whether or not variations in the plurality of evaluation results are within a predetermined range.

This apparatus increases the accuracy of an evaluation by detecting an abnormal value that is unnecessary for the evaluation results.

A medical training apparatus according to a twelfth aspect further includes a measurement equipment evaluation input unit that inputs a measurement result based on the training session, wherein the training-evaluation-information storage unit stores the evaluation result that includes the measurement result for the measurement equipment evaluation input unit in association with the history information.

This apparatus acquires much more information and evaluation results that are useful for a training session.

A medical training apparatus according to a thirteenth aspect further includes a voice processing unit that processes a voice based on the training session and supplies information about the voice that has been processed to either the training-history-information storage unit or the operation unit.

This apparatus enables the voice input of a comment for each evaluation result or for each item, and also enables the evaluation of verbal communication during the course of a training session.

A medical training apparatus according to a fourteenth aspect includes a configuration that can be used for the self-learning by a trainee by calling up at least any one or more of the evaluation result, the result of the operation unit, and the history information that has been associated with either the evaluation result or the result of the operation unit.

This apparatus enables a trainee to independently perform a training session with this apparatus.

A medical training apparatus according to a fifteenth aspect includes a configuration that enables training of an evaluator by calling up at least any one or more of the evaluation result, the result of the operation unit, and the history information that has been associated with either the evaluation result or the result of the operation unit and then inputting a new evaluation result with the evaluation input unit.

This apparatus enables an evaluator to evaluate the training with this apparatus.

Note that the term “evaluator” as used herein refers to all persons who perform an evaluation action using the present invention. Thus, an evaluator who evaluates the training is not limited to a person such as an instructor or a professor, but also includes a person such as a trainee or a student who has received guidance.

These and the other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram of a medical training apparatus according to a first preferred embodiment.

FIG. 2 is a functional block diagram of the medical training apparatus according to the first preferred embodiment.

FIG. 3 is a flow chart showing the operations of the medical training apparatus according to the first preferred embodiment.

FIGS. 4A and 4B illustrate medical training scenarios used in the medical training apparatus according to the first preferred embodiment.

FIG. 5 illustrates a mode selection display used in the medical training apparatus according to the first preferred embodiment.

FIG. 6 illustrates images displayed in a self-learning mode of the medical training apparatus according to the first preferred embodiment.

FIG. 7 illustrates evaluation item data used in the medical training apparatus according to the first preferred embodiment.

FIG. 8 illustrates an evaluation input unit used in the medical training apparatus according to the first preferred embodiment.

FIG. 9 illustrates an evaluation input unit used in the medical training apparatus according to the first preferred embodiment.

FIG. 10 illustrates the result of an evaluation performed using the medical training apparatus according to the first preferred embodiment.

FIG. 11 illustrates a total result for evaluation results obtained by the medical training apparatus according to the first preferred embodiment.

FIG. 12 is a diagram explaining the input of an evaluation comment in the medical training apparatus according to the first preferred embodiment.

FIG. 13 is a diagram explaining images captured from a plurality of angles and displayed in a medical training apparatus according to a second preferred embodiment.

### DESCRIPTION OF THE PREFERRED EMBODIMENTS

### First Preferred Embodiment

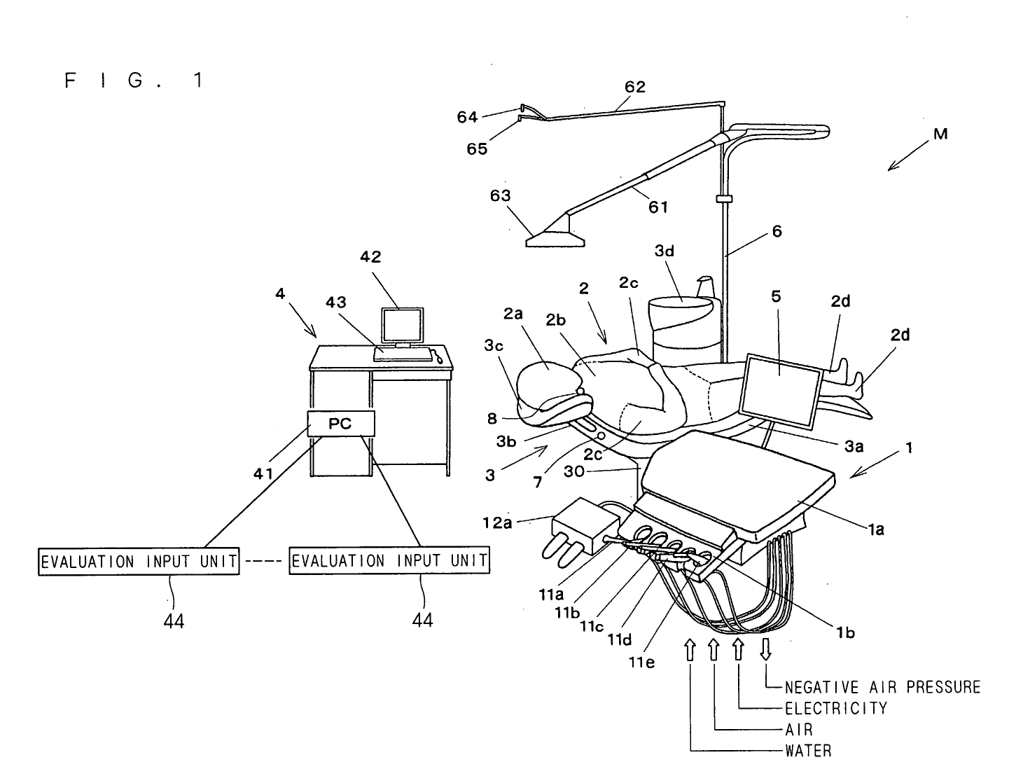

FIG. 1 is a schematic diagram of a medical training apparatus according to the present preferred embodiment. A medical training apparatus M illustrated in FIG. 1 includes an instrument table 1 that is equipped with medical instruments 11a to 11e, an imitation patient body 2 that imitates a patient, an examination table 3 on which the imitation patient body 2 is placed for treatment, and an information processor 4 that serves as a GUI to display a variety of information and to accept various instructions that are given to the imitation patient body 2.

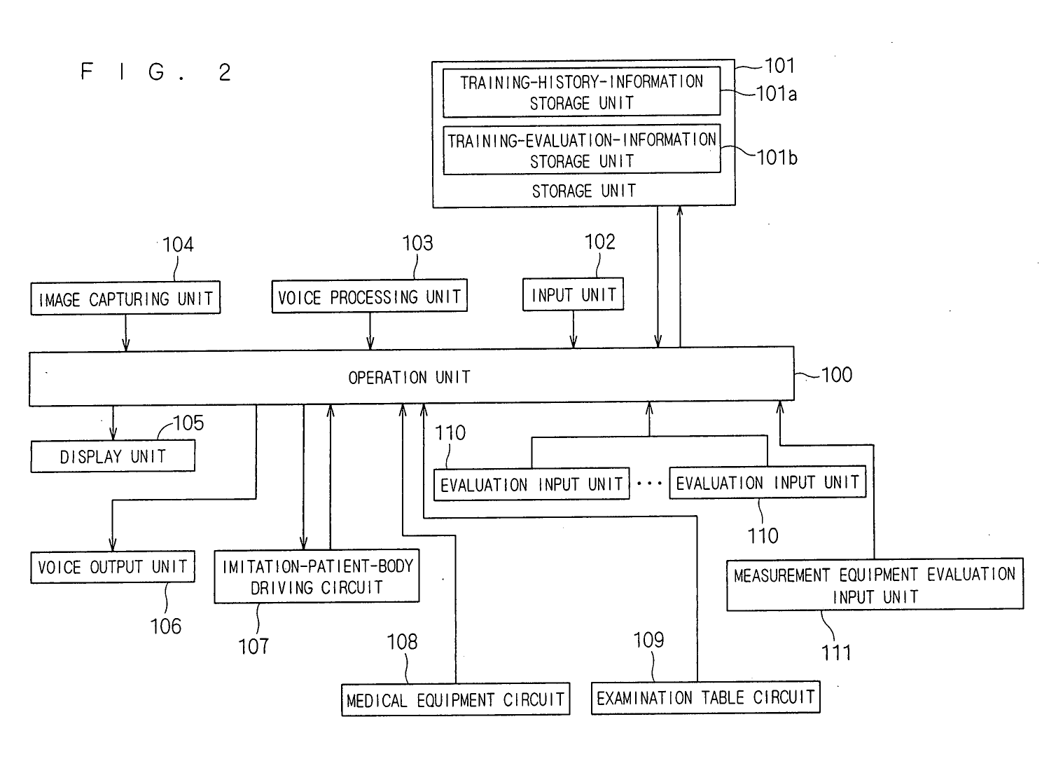

The instrument table 1 includes an instrument holder 1b that is provided on this side of a table 1a that is rotatably attached to the examination table 3 with an arm (not shown). Medical instruments 11a to 11e such as cutting tools (e.g., an air turbine handpiece, a micromotor handpiece), a scaler, a three-way syringe, and a vacuum syringe are detachably attached to the instrument holder 1b. The instrument table 1 is also provided with a display unit 5 that is located above the table 1a. With the display unit 5, a medical chart for a patient can be called up and displayed, or information as to training, such as content regarding the operation of medical instruments during the course of training, can be monitored. The medical instruments may include, in addition to the medical instruments 11a to 11e illustrated in FIG. 1, an intra-oral camera or a photo polymerization irradiator (both of which are not shown). A foot controller 12a is provided to control those medical instruments. Also, a medical equipment circuit (cf. the functional block diagram of FIG. 2) is provided to detect the operating conditions of those medical instruments.

The medical instruments 11a to 11e may be configured so as to be capable of being driven upon detection of their removal from the instrument holder 1b, or driven upon detection of the operation of the foot controller 12a, or driven upon detection of the operation of operation units that are provided within the medical instruments. The instrument holder 1b may not necessarily be mounted on the instrument table 1 as illustrated in FIG. 1. It may be mounted on the examination table 3, for example; in other words, the instrument holder 1b may adopt any of various configurations that enable the medical instruments 11a to 11e to be detachably mounted thereon irrespective of where it is located. The medical equipment circuit detects the number of revolutions of the medical instruments 11a to 11e or the voltage and current values that correspond to that number of revolutions; or an air pressure, an air flow rate, a frequency, and the number of vibrations at which the medical instruments work; or a pressure applied to the imitation patient body 2 when the medical instruments 11a to 11e are in contact with the imitation patient body 2; or an actuating signal of the foot controller 12a that is connected to the examination table 3. The medical instruments 11a to 11e are connected to a water supply source, an air supply source, and an air suction part; this is well known and thus will not be discussed herein.

The imitation patient body 2 includes a head model 2a, a body model 2b, right and left arm models 2c, and right and left leg models 2d. The imitation patient body 2 is provided with a built-in imitation-patient-body driving circuit (cf. the functional block diagram of FIG. 2) that changes the posture or facial expression of the imitation patient body 2, detects the conditions of a medical procedure performed on the imitation patient body 2, and transmits detected information to an operation unit. In order to make the imitation patient body 2 remarkably similar in appearance to a human body, the imitation patient body 2 has either a wig or implanted hair on its head, and an artificial skin on the surface. The imitation patient body 2, unlike any conventional type whose skeleton is made of mechanical parts, is configured as a so-called android robot that has an artificial skin and artificial hair put thereon so as to be quite similar to a human body; during training, it is placed on the examination table 3 for various treatments, as in the case of a human body. The imitation patient body 2 is connected to driving sources for supplying mechanical, electrical, and fluid energies (working media) so as to change its posture or facial expression. The imitation patient body 2 may also be configured to be united or operated in conjunction with the examination table 3, or as another alternative, it may be configured to operate independently. Note that Patent Document 1 provides a detailed description of the configuration or drive, etc. of an imitation patient body 2.

The examination table 3 includes a seat 3a that is mounted on a base 30 so as to be movable up and down, a tiltable backseat 3b that is connected to the rear side of the seat 3a, and a tiltable headrest 3c that is connected to the top end of the backseat 3b. In order to adjust it to an optimum position depending on the medical situation, the examination table 3 includes a seat-elevating unit, a backseat-tilting unit, and a headrest-tilting unit (all of which are not shown) that operate under the control of the foot controller 12a. Such a seat-elevating unit and a backseat-tilting unit may be hydraulic cylinders or electric motors, etc. as used in conventional techniques, and such a headrest-tilting unit may be an electric motor, etc.

The examination table 3 is also provided with an additional stand pole 6 for treatment. This stand pole branches on the way and includes arms 61 and 62 that extend rotatably. The arm 61 is provided with an astral lamp 63, and the arm 62 is provided with an image pickup camera 64 (image capturing unit) that captures the handling of the medical instruments 11a to 11e by a trainee, the movements of the trainee, changes in the posture, movements, and facial expressions of the imitation patient body 2, and so on; and a microphone 65 for collecting verbal communication or the like during treatment. The microphone may be placed in the vicinity of an ear or shoulder of the imitation patient body in order to reproduce a situation close to the actual medical situation, or it may be placed at any other position, such as on the examination table. Note that a spittoon 3d that includes a water tap for supplying water for use in rinsing the mouth and a cuspidor bowl is provided in the vicinity of the examination table 3.

The information processor 4 is a workstation, for example, and includes a PC body 41, a display unit 42 such as an LCD monitor, an operation unit 43 such as a keyboard or a mouse, etc., and an evaluation input unit 44 with which an evaluator who evaluates the training inputs his or her evaluation result. There may be a plurality of evaluation input units 44. With a plurality of evaluation input units 44, a plurality of evaluators can perform evaluations at the same time. In the exemplary example of FIG. 1, the evaluation input units 44 are directly connected to the PC body 41 with cables; however, the method of connection is not limited thereto; a wireless unit or any other communication unit may be used for the connection.

The display unit 42 displays a variety of information as GUI information and accepts various instructions that have been input through the operation unit 43 such as a keyboard or a mouse by referring to the display. The display unit 42 displays the situation of a consultation with the imitation patient body 2 during training, the situation of evaluations, and the like; upon request, it is capable of displaying necessary information at any time. The imitation patient body 2 may be actuated by the PC body 41 storing and executing a specific program. In particular, a training instructor can manipulate the facial expressions or movements of the imitation patient body 2 with the operation unit 43 or the like while comprehending the situation of a trainee. Alternatively, any of various sensors built in various parts of the imitation patient body 2 may be called up in order to display detection signals on the monitor.

At the shoulder portion of the backseat 3b, a system shutdown control switch 7 is provided. This system shutdown control switch 7 is an emergency shutdown switch that stops the whole system (the imitation patient body 2, the examination table 3, the medical instruments 11a to 11e, and the like) when at least either the imitation patient body 2 or the examination table 3 malfunctions. This system shutdown control switch 7 may preferably be placed at the shoulder portion of the backseat 3b because of the ease of operation by a trainee, but its position may appropriately be selected and determined in consideration of accessibility for a trainee; for example, it may be placed in the vicinity of the instrument table 1 or in the vicinity of the headrest 3c. The target to be stopped may preferably be the whole system; safety can be ensured as long as at least the operations of the imitation patient body 2 and the examination table 3 are stopped.

An imitation-patient-body power-reduction control switch 8 that drives an imitation-patient-body power reducing portion is provided at the neck portion of the imitation patient body 2. This imitation-patient-body power-reduction control switch 8 is a switch that accepts the operation for releasing all or part of the operating pressures (e.g., an air pressure, a fluid pressure) that serves as working media (e.g., air, water, oil) in order to drive the imitation-patient-body power reducing portion. An open nozzle (not shown) is provided at some point in a driving system (duct line system) of such working media; the open nozzle is opened by the operation of the imitation-patient-body power-reduction control switch 8 so as to discharge the working media out of the system. This imitation-patient-body power-reduction control switch 8 may preferably be provided at the neck portion of the imitation patient body 2 in terms of accessibility for a trainee, but as described above, its position may appropriately be selected and determined in consideration of accessibility for a trainee; for example, it may be placed at a temporal region of the imitation patient body 2, in the vicinity of the instrument table 1, or in the vicinity of the headrest 3. Alternatively, the imitation-patient-body power-reduction control switch 8 may be combined with the system-shutdown control switch 7 described above and may be used for both system shutdown and subsequent power reduction of the imitation patient body 2.

The medical training apparatus according to the present invention can be implemented as illustrated in the schematic diagram of each device of the medical training apparatus illustrated in FIG. 1; this schematic diagram is only one example and the medical training apparatus according to the present invention is not limited to the configuration and form illustrated in this schematic diagram.

FIG. 2 is a functional block diagram of the medical training apparatus according to the present preferred embodiment. The functional block diagram illustrated in FIG. 2 includes an operation unit 100 that may be implemented by the information processor 4 illustrated in FIG. 1, a storage unit 101 that is connected to the operation unit 100, an input unit 102, a voice processing unit 103, an image capturing unit 104, a display unit 105, a voice output unit 106, an imitation-patient-body driving circuit 107, a medical equipment circuit 108, an examination table circuit 109, an evaluation input unit 110, and a measurement equipment evaluation input unit 111.

The storage unit 101 may be implemented by a storage device included in the PC body 41 or an external storage device unit connected to the PC body 41. The storage unit 101 includes a training-history-information storage unit 101a and a training-evaluation-information storage unit 101b; they may be implemented by either a single storage device or separate storage devices. In the present example, the training-history-information storage unit 101a stores history information (training history) about a training session performed based on a preset medical training scenario. Note that the term “medical training scenario” as used herein refers to information that organizes basic actions and verbal communications of a trainee or both a trainee and a patient during the course of medical training in a time sequence. Since the history information (training history) about a training session includes an actual training session that has been performed under such a medical training scenario, it also includes, in addition to the information about a medical training scenario, the actions and verbal communications of a trainee or both a trainee and a patient. The training-evaluation-information storage unit 101b stores the evaluation results that have been input with the evaluation input unit 110 or the like and results that have been obtained by the operation unit 100, in association with the history information.

The input unit 102, which may be implemented by the operation unit 43 or the like illustrated in FIG. 1, is configured to input information for use in controlling the processing performed by the operation unit 100 and the imitation patient body 2. For example, although the imitation patient body 2 includes a sensor or mechanism that essentially does not malfunction, medical procedures performed by a trainee may in some cases cause the imitation patient body 2 to malfunction; in such a case, a third party can use the input unit 102 to correct such a malfunction. By a third party using the input unit 102 to control the imitation patient body 2, it is also possible to train a trainee or an evaluator in the decision-making or management skills when encountering an unexpected situation. Examples of an unexpected situation that can be caused under control include, for example, where the imitation patient body 2 suddenly moves its arm 2c, where the imitation patient body 2 caused a physiological phenomenon such as sneezing or coughing, and where the imitation patient body 2 talks to a trainee. Note that, when the imitation patient body 2 is caused to verbally communicate with a trainee, a PC microphone (not shown) may be used as the input unit 102 that inputs voice data. For example, voice data that a third party has inputted through a PC microphone may be output through the imitation patient body 2 or the like so as to be used for the training of a trainee in management skills when encountering verbal communication with a patient.

The voice processing unit 103 performs voice recognition processing or the like, i.e., recognizes the verbal communications of a trainee that have been input through the microphone 65. Although not included in a preset medical training scenario, voice data or the like that has been input through the above-described PC microphone for a third party (not shown) and used as a verbal communication of the imitation patient body 2 through the patient body or the like may also be subjected to voice recognition processing and stored as training history information in the training-history-information storage unit 101a. The image capturing unit 104 may be implemented by the image pickup camera 64 illustrated in FIG. 1, and capture images during the course of a training session. Note that, while only a single image pickup camera 64 provided above the imitation patient body 2 is illustrated in FIG. 1, the image capturing unit 104 according to the present invention is not limited thereto; it may be configured to include other cameras that capture images from a variety of angles, such as a camera that captures an image of the imitation patient body 2 from a side surface portion or a camera that captures an intra-oral image. A camera used for image capturing may preferably have wide-angle and zooming capabilities. The display unit 105 may be implemented by the display unit 5 or the display unit 42 illustrated in FIG. 1, and displays content on the operation of the medical instruments for monitoring or displays a medical training scenario, evaluation results, and the like.

The voice output unit 106, which may be implemented by a speaker or the like (not shown) that is provided on the PC body 41 or the imitation patient body 2 illustrated in FIG. 1, outputs the verbal communications of the imitation patient body 2, sound stored in the history information, and the like. The imitation-patient-body driving circuit 107 that is a driving circuit for controlling the imitation patient body 2 drives each drive unit provided in the imitation patient body 2, based on information obtained from the operation unit 100 or the input unit 102, or information obtained from a medical training scenario. The imitation-patient-body driving circuit 107 also transmits a signal that has been output from a sensor provided in the imitation patient body 2, to the operation unit 100. The medical equipment circuit 108 transmits information obtained from the medical instruments 11a and so on illustrated in FIG. 1 to the operation unit 100 in the form of a signal. The examination table circuit 109 transmits information obtained from the examination table 3 illustrated in FIG. 1 to the operation unit 100 in the form of a signal. The evaluation input unit 110 is used by an evaluator who evaluates the training of a trainee to input his or her evaluation result for the training session. If there are a plurality of evaluators evaluating at the same time, an evaluation input unit 110 is prepared for each evaluator. Note that the evaluation input unit 110 and the operation unit 100 may be directly connected with cables as illustrated in FIG. 1 or they may be connected via wireless or a network on-line on the Internet.

The measurement equipment evaluation input unit 111 is used to input the results of measurement by external measurement equipment or the like, other than the evaluation results that has been input by an evaluator. For example, the evaluation results obtained by a predetermined measuring device evaluating a subject of evaluation that has been produced by training (e.g., a tooth cut during training) is input into the operation unit 100. The operation unit 100 also stores the measurement results and/or the evaluation results that have been input with the measurement equipment evaluation input unit 111 in the training-evaluation-information storage unit 101b, together with the other evaluation results. As described above, the medical training apparatus according to the present preferred embodiment is configured of the functional blocks illustrated in FIG. 2; of which those functional blocks are only one example, and the configuration of the medical training apparatus according to the present invention is not limited to those functional blocks.

For example, the configuration may be either such that processing, such as generating history information about a training session or generating training evaluation information that associates the results of operation unit and the evaluation results with the history information, is performed by the operation unit 100 and only information (data) about the result of that processing is stored in the storage unit 101; or such that such processing is performed by the training-history-information storage unit 101a and the training-evaluation-information storage unit 101b that are included in the storage unit 101. While the medical equipment circuit 108 is directly connected to the operation unit 100 in FIG. 2, the present invention is not limited thereto; the medical equipment circuit 108 may be connected to the operation unit 100 via the imitation-patient-body driving circuit 107. In addition, while the examination table circuit 109 is also directly connected to the operation unit 100 in FIG. 2, the present invention is not limited thereto; the examination table circuit 109 may be connected to the operation unit 100 via the imitation-patient-body driving circuit 107. In the example of FIG. 2, the imitation-patient-body driving circuit 107 is provided on the premise that the imitation patient body 2 is provided; however, the medical training apparatus according to the present invention may be configured not to include the imitation-patient-body driving circuit 107 because it may use an actual patient, instead of the imitation patient body 2. Similarly, the medical training apparatus according to the present invention may be configured not to include the voice output unit 106.

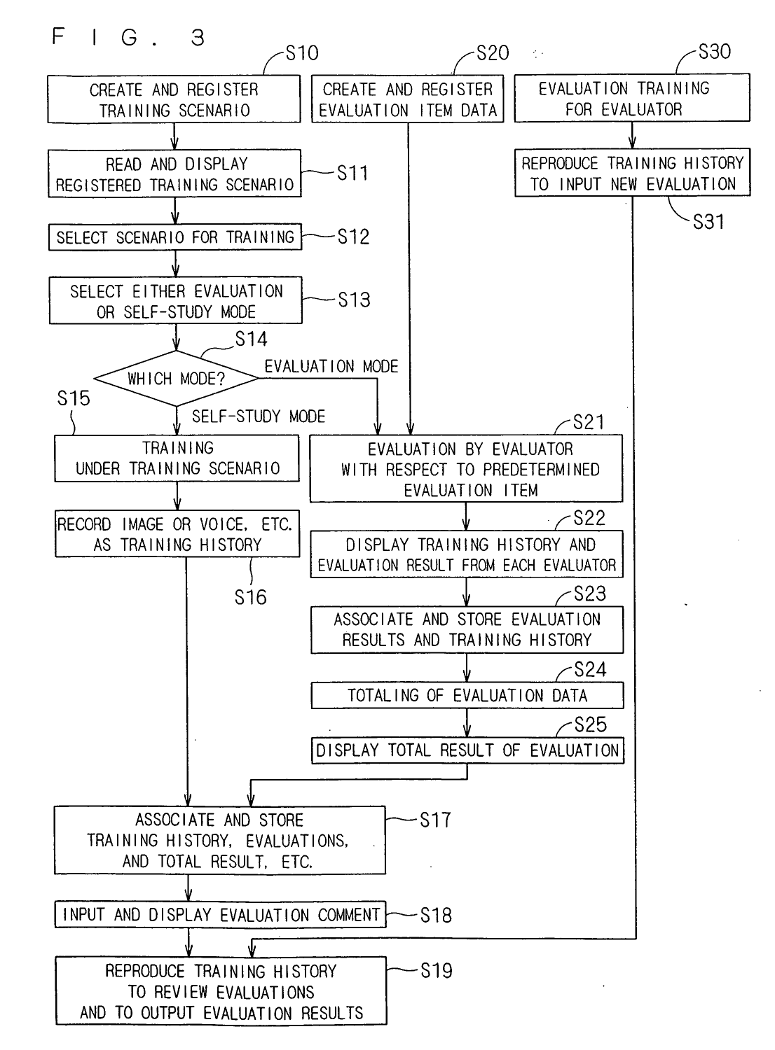

Next, the operations of the medical training apparatus according to the present preferred embodiment will be described with reference to the flow chart of FIG. 3. Note that the operations based on this flow chart are performed by the operation unit 100 reading a predetermined program stored in the storage unit 101 or the like.

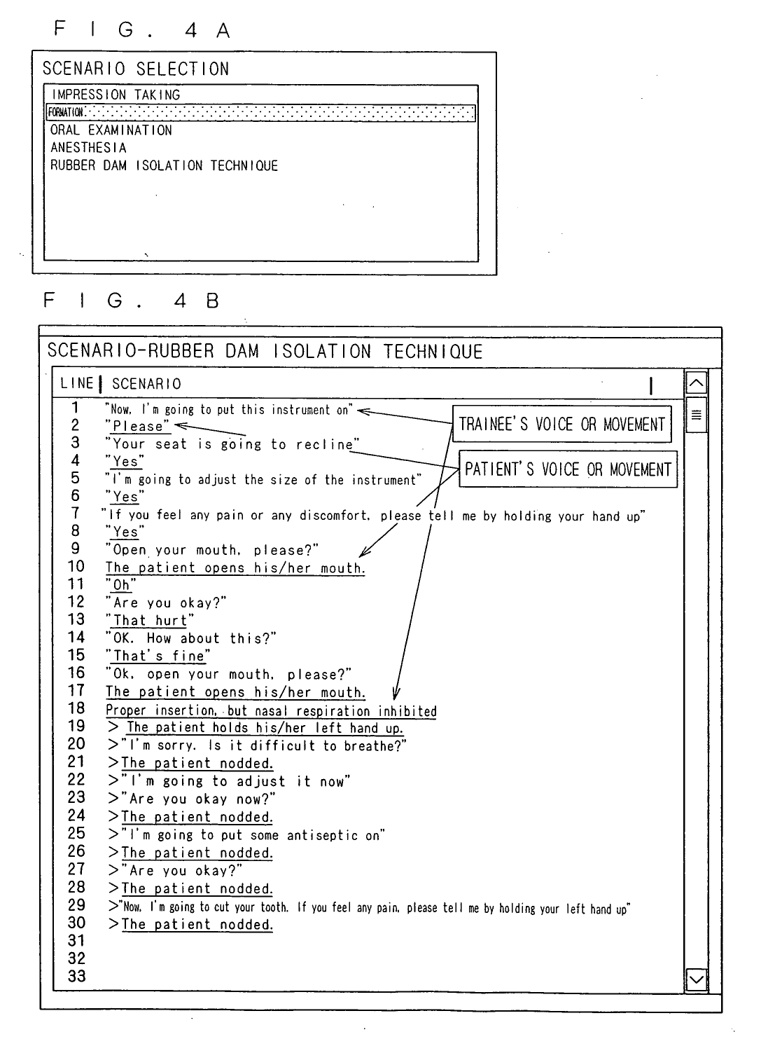

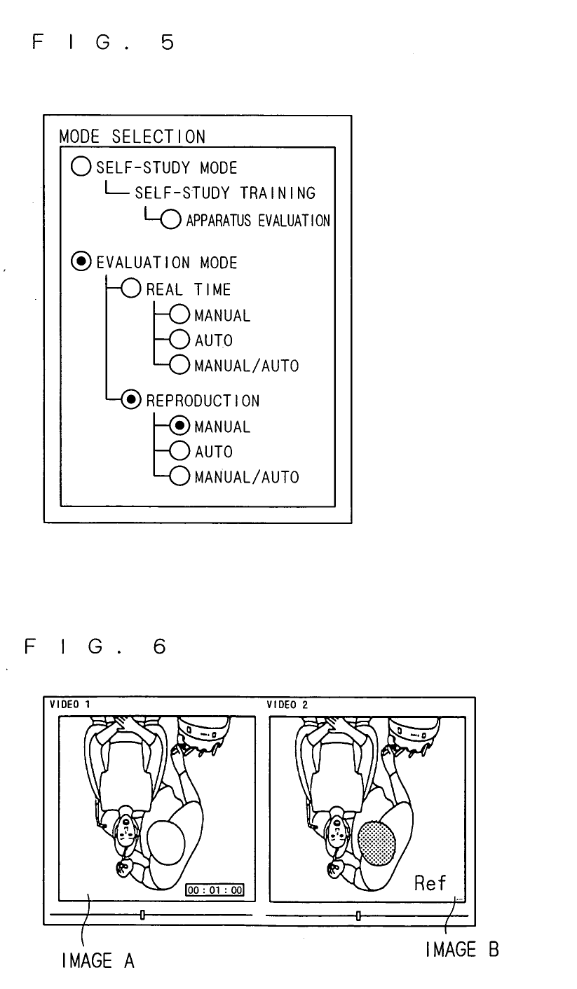

First, a medical training scenario used in the medical training apparatus according to the present preferred embodiment is created and registered in step S10 in FIG. 3. A medical training scenario is created for each item of training. Specifically, a medical training scenario is created for each of such items as impression taking, formation, oral examination, anesthesia, moisture control with a rubber dam isolation technique, as illustrated in FIG. 4A. As one example of such medical training scenarios to be created, part of a medical training scenario for moisture control with a rubber dam isolation technique is concretely illustrated in FIG. 4B. As illustrated in FIG. 4B, a medical training scenario is created by describing the basic verbal communications and movements of a trainee and a patient that are necessary for training (e.g., moisture control with a rubber dam isolation technique) in a time sequence. Note that such a medical training scenario is stored in a storage device provided in the information processor 4 by the storage unit 1001.

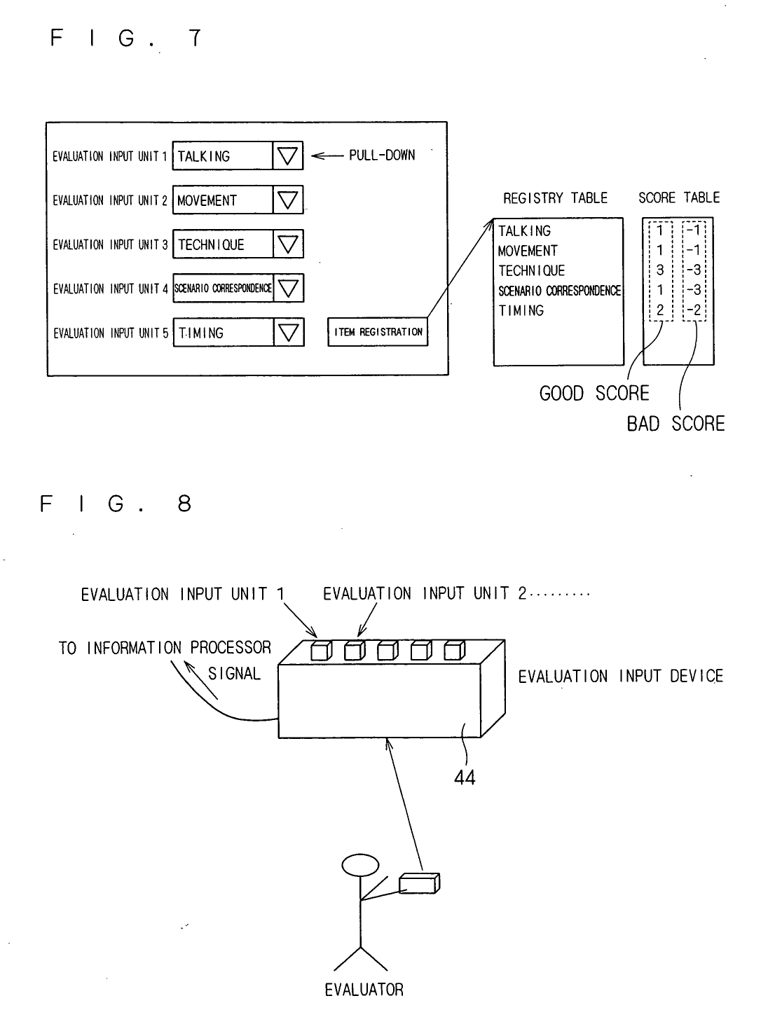

Then, in step S11, the medical training scenarios stored in the storage device are read by the operation unit 100 illustrated in FIG. 2 and displayed in list form on the display unit 105 as illustrated in FIG. 4A. In step S12, one medical training scenario is selected from among the items displayed as illustrated in FIG. 4A. In addition, an execution mode of the medical training apparatus is selected in step S13. As illustrated in FIG. 5, the medical training apparatus according to the present preferred embodiment has two execution modes, namely a self-learning mode and an evaluation mode. The term “self-learning mode” as used herein refers to an operation mode in which a trainee independently performs a training exercise (self-learning training) of a medical procedure based on a medical training scenario, using the medical training apparatus. When this self-learning mode is selected with a setting tool or the like that enables mode selection using radio buttons as illustrated in FIG. 5, self-learning training is performed. This self-learning training is basically performed without an evaluator, but the apparatus can output the evaluation results of items that are automatically evaluated by the apparatus itself. Thus, if the results of evaluation by the apparatus are necessary, the “Apparatus Evaluation” radio button in FIG. 5 is selected in the self-learning mode.

On the other hand, the term “evaluation mode” as used herein refers to an operation mode in which an evaluator inputs his or her evaluation result for a training session performed with the medical training apparatus. Note that, in the medical training apparatus according to the present preferred embodiment, the evaluation mode has two options: the option of evaluating a real-time training session and the option of reproducing history information (training history) about a training session and evaluating the training session; either option is selected with a radio button illustrated in FIG. 5. In the medical training apparatus according to the present preferred embodiment, each of the above two options further includes three options: the option of manual input where an evaluator manually inputs his or her evaluation result; the option of automatic input where the apparatus automatically performs evaluations and inputs its evaluation result; and the option of manual and automatic input where both manual and automatic inputs are possible; any one of the options is selected with a radio button illustrated in FIG. 5. In the evaluation mode, the apparatus can be used not only for the normal evaluation of a training session, but also for an evaluator's training for evaluation using the option of reproduction in FIG. 5 where the training history or evaluation results that have already been stored in the storage unit 101 are reproduced to perform a new evaluation. Note that the mode selection menu illustrated in FIG. 5 is only one example, and varieties of options, the arrangement of options, and the method for selecting an option are not limited to those described above; the mode selection menu may be set properly for the purpose of using the medical training apparatus according to the present invention.

In step S14, the selected mode is determined. When the self-learning mode is selected in step S13, the process goes to step S15, whereas when the evaluation mode is selected in step S13, the process goes to step S21. In step S15, a trainee performs training based on the medical training scenario selected in step S12. Note that, in this step or in the self-learning mode, there is no evaluator who performs a manual evaluation. In step S16, a training history of the training session that has been performed under the medical training scenario is obtained with the image pickup camera 64 and the microphone 65 illustrated in FIG. 1. At this time, signals from the sensors provided in the imitation patient body 2, the medical instruments 11a and so on, and the examination table 3 are also obtained as training history.

Then, in step S17, the training history obtained in step S16 is associated with the results of evaluation by the apparatus, or the like, which are obtained when “Apparatus Evaluation” is selected from the mode selection menu in FIG. 5, and then stored in the storage unit 101 (training-evaluation-information storage unit 101b). In step S18, as described later, it is possible to input an evaluation comment into the training history or the evaluation results or to display a current input comment or an already input evaluation comment. In addition, it is also possible in step S19 to reproduce the training history obtained in step S16 so that a trainee can input his or her own evaluation. Note that, in the case of reproducing a training history in step S19, for example as illustrated in FIG. 6, an image A that represents a trainee's own training history may be displayed on the left side of the display unit 105 (42, 5) and an image B that represents another person's training history based on the same medical training scenario may be displayed as a reference (Ref) on the right side of the display unit 105 (42, 5), which enables a trainee to perform an objective evaluation of his or her own training session through comparison. Note that the configuration of the screen is not limited to the above example. Also, the method for comparing training history information is not limited thereto. Since such a comparison is possible between any different training histories based on the same medical training scenario; as another alternative, a comparison may be made between one's early-stage and post-training training images, or a comparison may be made between one's evaluation result and another person's evaluation result, for use in one's own learning.

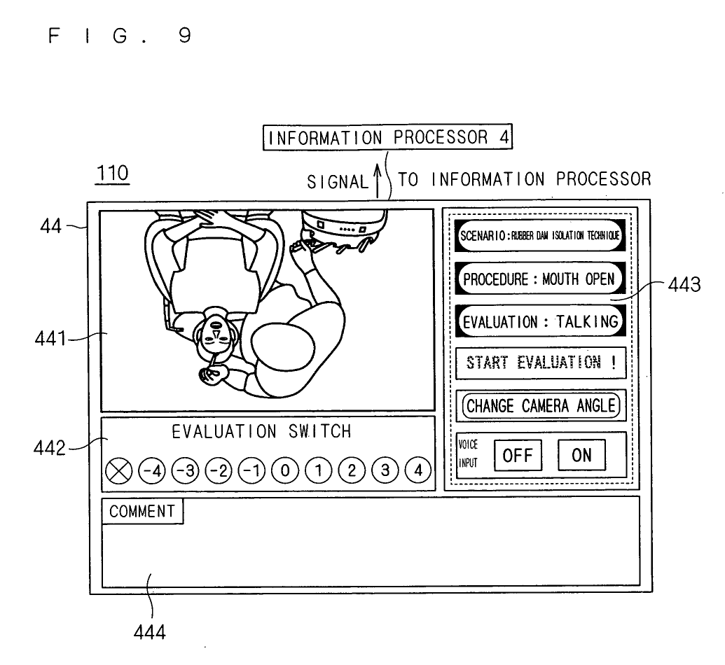

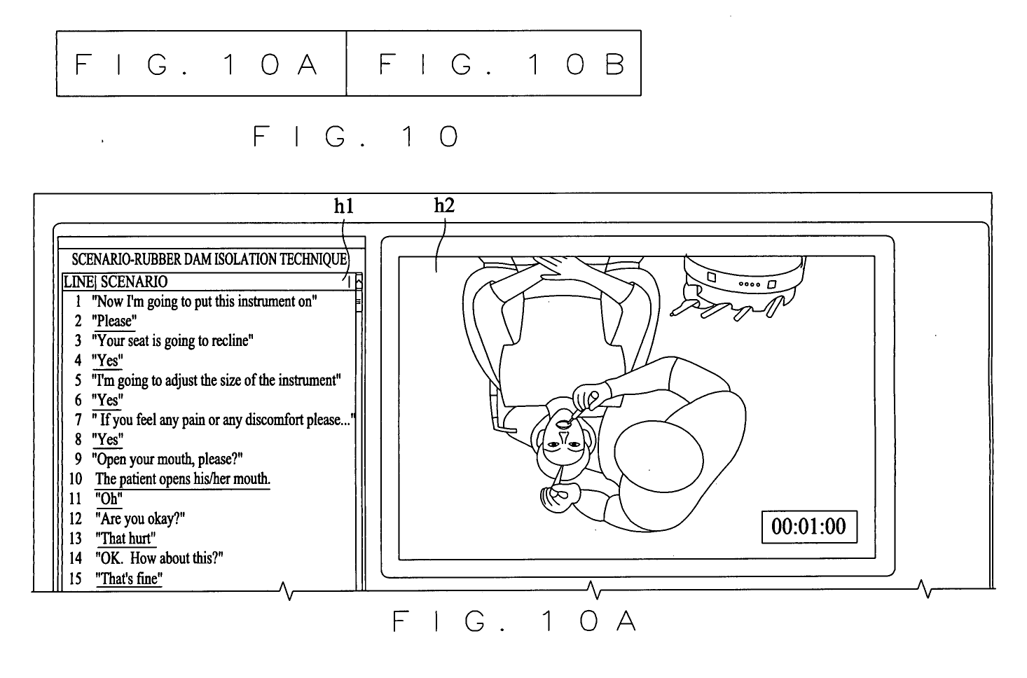

In the case of evaluating a training session in the evaluation mode, it is first necessary to create and register evaluation item data in step S20. Here, since the evaluation of a training session is performed with respect to different evaluation items for each predetermined matter (e.g., a medical training scenario for impression taking or for oral examination, etc., verbal communications or movements defined in a medical training scenario), evaluation items are set for each matter on an evaluation-item input screen illustrated in FIG. 7. A “predetermined matter” as used herein refers to a unit of evaluation and includes at least any one of an individual evaluation of each action during training, an individual evaluation of a series of actions during training, and a comprehensive evaluation of a scenario for each unit of evaluation. Specifically, an evaluation item for each evaluation input unit of an evaluation input device in FIG. 8, which is the evaluation input unit 110, is set on the evaluation-item input screen illustrated in FIG. 7. For example, “Talking” is selected for an evaluation input unit 1 from a pull-down menu on the evaluation item input screen illustrated in FIG. 7; similarly, “Movement” is selected for an evaluation input unit 2, “Technique” for an evaluation input unit 3, “Scenario Correspondence” for an evaluation input unit 4, and “Timing” for an evaluation input unit 5, which creates evaluation item data. Note that the items that can be selected from the pull-down menu are stored in a registry table that can be edited in an item directory field. As to the setting of the evaluation items, all evaluators may input their evaluations under the same setting, or each evaluator may input his or her evaluation under a different setting.

A score system, in which a score is recorded when an evaluator presses each evaluation input unit of the evaluation input device illustrated in FIG. 8, is set for each evaluation input unit according to a score table illustrated in FIG. 7. The score table defines the points of a score, a score label, and a score range. In the exemplary example of FIG. 7, a positive value indicates a score for a good evaluation with respect to an evaluation item, whereas a negative value indicates a score for a bad evaluation with respect to an evaluation item. In the present preferred embodiment, the range of each score is determined depending on the degree of importance of the evaluation contents in a training session. A signal for each evaluation input unit that has been pressed in the evaluation input device in FIG. 8 is transmitted to the information processor 4 including a PC that is the operation unit 100. The evaluation input units of the evaluation input device in FIG. 8 are button types that may be configured to support three-scale evaluations: “good,” “neither good nor bad,” and “bad.” The method of inputting evaluations according to the present invention is not limited to this system; it may adopt any other system such as a switch system or a dial system. For example, it may be set so as to support a smaller-scaled score system that enables nine-scale evaluations in which both positive and negative values increase up to two points in increments of 0.5. The evaluation input unit 10 according to the present invention may adopt any system as long as it is configured to be at least capable of including all the necessary options for evaluation items and inputting evaluation results in the form of data that can be computed and totaled.

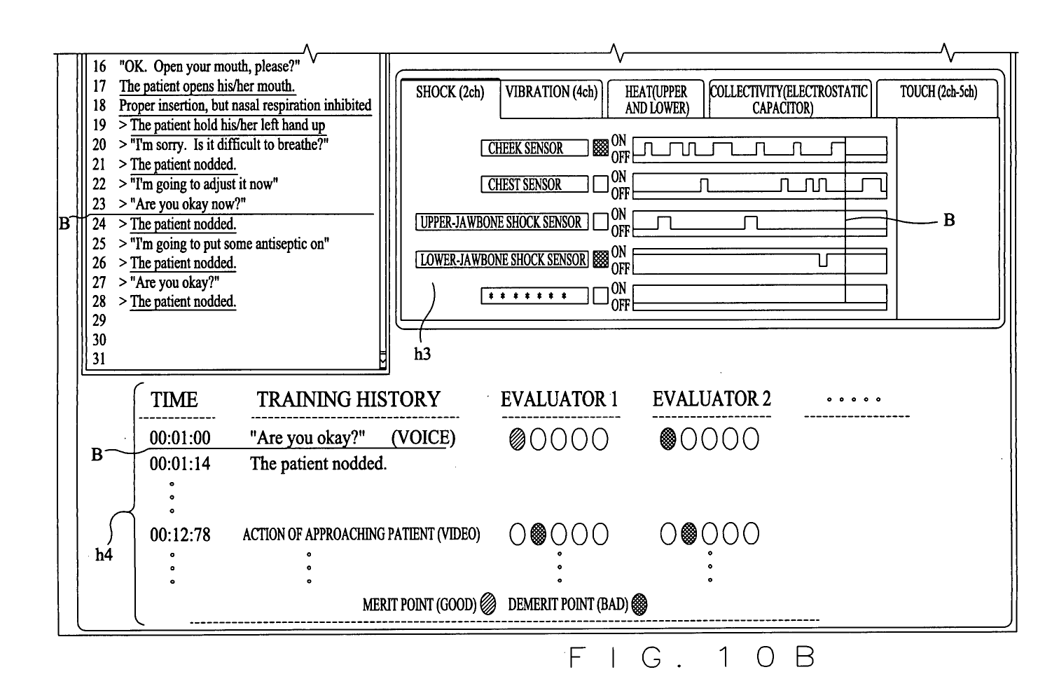

Next, in step S21, an evaluation by an evaluator with respect to a predetermined evaluation item is accepted based on the training history of a real-time training session or the reproduced training history of a previously performed training session. Note that such an evaluation may employ either a summation or subtraction method. The method of evaluation is not particularly limited as long as it can support diverse clinical needs. If an evaluator performs an evaluation while directly observing a training session, a simple evaluation input device such as illustrated in FIG. 8 that is equipped with a minimal mechanism that enables evaluation input may be sufficient enough; however, if an evaluator cannot directly observe a training session, an evaluation input unit 110 as illustrated in FIG. 9, for example, becomes necessary. Examples of such a case where a training session cannot be observed directly include, in addition to the case of performing an evaluation using a training history, the case of evaluating a real-time training session at a distant location. The evaluation input unit 110 (44) in the exemplary example of FIG. 9 includes a screen 441 that displays an image captured by the image pickup camera 64, a screen 442 that corresponds to an evaluation input unit, a screen 443 that displays control buttons for use in changing a medical training scenario, an evaluation item, the angle of a camera, and the like, and a comment input screen 444.

The evaluation input unit 110 (44) illustrated in FIG. 9 is configured to include a touch panel, so that the displayed control buttons or evaluation input unit can be selected by touching the panel. In the present preferred embodiment, an item for system shutdown is provided at the left edge of the screen 442 that corresponds to an evaluation input unit. The operation of the present training apparatus after system shutdown is as described above. With such a system shutdown item, not only a trainee who handles the imitation patient body 2 or the like or an operator of the information processor 4 such as a GUI but also an evaluator who handles the evaluation input unit 44 can take countermeasures, such as forcefully terminating the training, against eventualities that may occur during training. The comment input screen 444 displays a software keyboard not shown, and a comment can be input by touching this keyboard screen. Alternatively, the comment input screen 444 may employ a direct input system using a stylus pen (not shown), for example. Note that the evaluation input unit 110 (44) illustrated in FIG. 9 is provided with a voice output unit (not shown) such as a speaker or an earphone jack that is capable of outputting the sound of a training session that has been picked up through the microphone 65 or the sound made by the medical training apparatus. While the evaluation input unit 110 (44) illustrated in FIG. 9 uses cables to transmit and receive signals to and from the information processor 4 including a PC that is the operation unit 100, the present invention is not limited thereto; wireless or a network on-line on the internet or an off-line connection using a storage medium such as a memory card may be used instead.

Moreover, the configuration of the evaluation input unit 110 is not limited to those illustrated in FIGS. 8 and 9; for example, the configuration may be such that a microphone (not shown) that picks up the voice of an evaluator is provided as the evaluation input unit 110 in which evaluation results or evaluation comments are input in the form of verbal communication through the microphone and then converted back into data form by the voice processing unit 103. As another alternative, a microphone and a voice processing unit may be combined and configured as a new evaluation input unit 110.

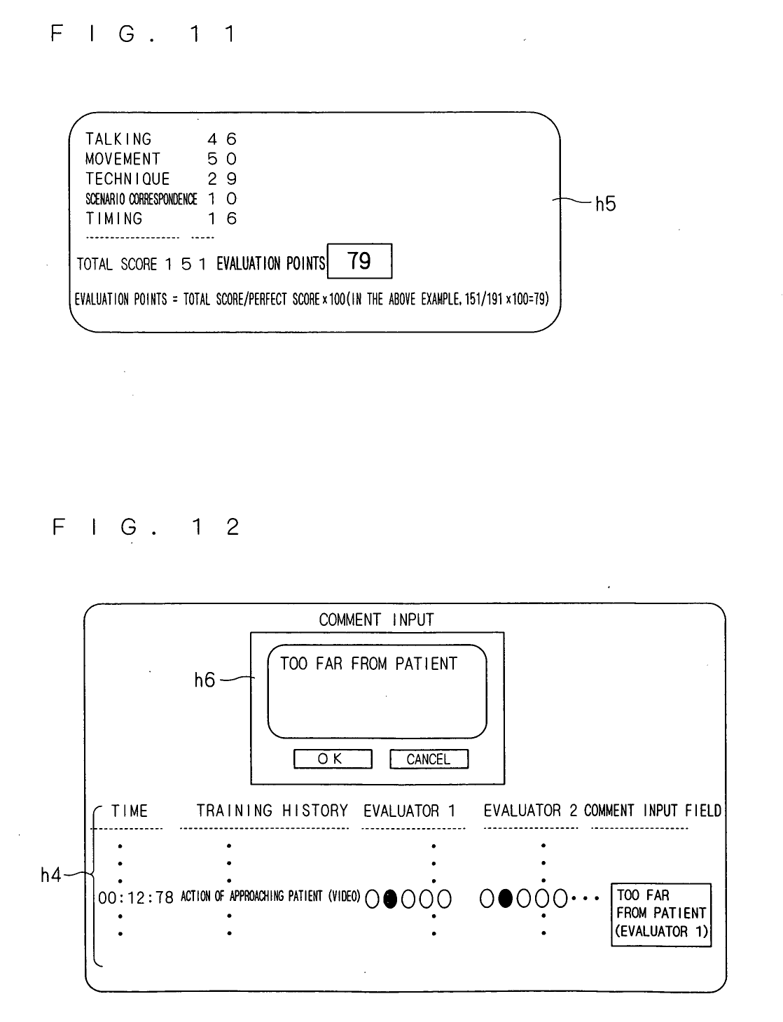

Next, in step S22, the training history and the evaluation results by each evaluator are displayed as illustrated in FIG. 10. The display screen illustrated in FIG. 10 includes a screen h1 that displays a medical training scenario, a screen h2 that displays an image captured by the image pickup camera 64, a screen h3 that displays the output of each sensor provided in the imitation patient body 2, and a screen h4 that displays the result of evaluation by an evaluator. The screen h1 that displays a medical training scenario displays the medical training scenario illustrated in FIG. 4B that has been selected in step S12. The screen h3 that displays the output of each sensor displays the outputs of a shock sensor, a vibration sensor, a thermal sensor, a conducting (electrostatic capacitance) sensor, and a touch sensor that are provided in the imitation patient body 2. Note that, on the screen illustrated in FIG. 10, a display of the output of each sensor is switched by pressing the tab key on the screen h3 that displays the output of each sensor. On the screen illustrated in FIG. 10, the time-sequential change in the signal that has been output from the shock sensor is currently being displayed. Note that the screen that displays the output of each sensor may display not only the outputs of the sensors provided in the imitation patient body 2 but also the output of a sensor or the like that is provided in the instrument table 1, the examination table 3, or the medical instruments 11a and so on.

The screen h4 that displays the result of evaluation by an evaluator displays the elapsed training time, the training history based on the medical training scenario, and the result of evaluation by an evaluator. In the present example, the training history displayed on the screen that displays evaluation results by evaluators is only some of the pieces of information that have been obtained by converting verbal communications or images into text form; however, the training history stored in the training-history-information storage unit 101a according to the present preferred embodiment also includes every piece of information that has been obtained from a training session, such as an image captured by the image pickup camera 64, the drive history of the imitation patient body 2, and the output of each sensor. However, the training history according to the present invention does not necessarily include every piece of information such as an image captured by the image pickup camera 64 and the output of each sensor; it may only include at least such history information that enables reproduction of a training session that has been performed based on a preset medical training scenario.

On the display screen illustrated in FIG. 10, an elapsed time bar B that corresponds to an elapsed training time (in FIG. 10, “00:01:00”) displayed on the screen h2 for displaying an image captured by the image pickup camera 64, is displayed on each of the screen h1 that displays a medical training scenario, the screen h3 that displays the output of each sensor, and the screen 4h that displays the results of evaluation by an evaluator. With these elapsed time bars B, the correspondence among the image captured by the image pickup camera 64, the part of the medical training scenario, and the part of the evaluation results can be seen at a glance.

Next, in step S23, the training-evaluation-information storage unit 101b stores the evaluation results in association with the training history. The association between the training history and the evaluation results is considered to be established using the elapsed training time as a key as illustrated in FIG. 10; the present invention is, however, not limited thereto; for example, such an association may be established using a flag provided in the training history (e.g., a mark assigned for each voice or movement of a trainee) as a key. Note that the evaluation results associated in step S23 are not limited to the evaluation results that have been input by an evaluator; they may include evaluation results that have been obtained through automatic evaluation by the medical training apparatus, or the results of measurement by external measurement equipment that have been input through the measurement equipment evaluation input unit 111 as evaluation results.

Now, the following exemplary scoring is considered for evaluation results that have been obtained through automatic evaluation by the medical training apparatus.

In the case where the selected medical training scenario is impression taking and the target evaluation movement is an impression taking technique, a criterion for evaluation shall be whether an overflow detection sensor that detects overflow into a soft palate provided in the imitation patient body 2 has reacted or not. Specifically, when a sensor for detecting a low amount of overflow has reacted, one demerit point is allocated; when a sensor for detecting a large amount of overflow has reacted, three demerit points are allocated; and when the overflow detection sensor has not reacted, one merit point is allocated.

In the case where the selected medical training scenario is formation and the target evaluation movement is cavity preparation, a criterion for evaluation shall be whether a sensor for detecting arrival at the dental pulp provided in the imitation patient body 2 has reacted or not. Specifically, when a shallow sensor for detecting arrival at the dental pulp has reacted, one demerit point is allocated; and when a deep sensor for detecting arrival at the dental pulp has reacted, three demerit points are allocated.

In the case where the selected medical training scenario is formation and the target evaluation movement is instrument handling, a criterion for evaluation shall be whether a front-tooth shock detection sensor provided in the imitation patient body 2 has reacted or not. Specifically, when the front-tooth shock detection sensor has reacted, one demerit point is allocated; and when the front-tooth shock detection sensor has not reacted, one merit point is allocated.

In the case where the selected medical training scenario is formation and the target evaluation movement is talking, the criteria for evaluation shall be the presence or absence of talking, such as “Are you all right?”, with the imitation patient body 2 and whether each detection sensor has reacted or not. Specifically, when the trainee's conversation has been recognized through voice recognition by the voice processing unit 103 and none of the sensors has reacted, the imitation patient body 2 is considered as having answered “Yes” and one merit point is allocated. When the trainee's talking has been recognized but any detection sensor has reacted, the imitation patient body 2 is considered as having said some words regarding pain and three demerit points are allocated. When the trainee's talking has not been recognized due to a low voice or the like, one demerit point is allocated.

In the case where the selected medical training scenario is formation and the target evaluation movement is posture, a criterion for evaluation shall be whether cheek and chest contact detection sensors provided in the imitation patient body 2 have reacted or not. Specifically, when either the cheek or chest contact detection sensor has reacted, one demerit point is allocated; when either the cheek or chest contact detection sensor has reacted for a predetermined period of time, three demerit points are allocated; and when both the cheek and chest contact detection sensors have not reacted, neither a merit nor a demerit point is allocated.

In the case where the selected medical training scenario is formation and the target evaluation movement is saliva suction or the like, a criterion for evaluation shall be a numerical value of a liquid measurement sensor or the like provided in the oral cavity of the imitation patient body 2. Specifically, when the value of the liquid measurement sensor is between 0 and X cc, one demerit point is allocated; when the value of the liquid measurement sensor is between X and Y cc, one merit point is allocated; when the value of the liquid measurement sensor is between Y and Z cc, neither merit nor demerit point is allocated; and when the value of the liquid measurement sensor is Z cc or higher, two demerit points are allocated (X<y<Z).

In the case where the selected medical training scenario is formation and the target evaluation movement is correctness in the forming of an object, a criterion for evaluation shall be whether any shock detection sensor provided in a region of the imitation patient body 2 other than the region of the formation has reacted or not. Specifically, when any shock detection sensor provided in a region other than the region of the object to be formed (e.g., a tooth or any region in the oral cavity) has reacted, three demerit points are allocated; and when none of the shock detection sensors provided in a region other than the region of the object to be formed has reacted, neither merit nor demerit point is allocated.

In the case where the selected medical training scenario is formation and the target evaluation movement is a continuous mouth-opening time, a criterion for evaluation shall be the continuous mouth-opening time detected by a mouth-opening detection sensor provided in the imitation patient body 2. Specifically, when the continuous mouth-opening time detected by the mouth-opening detection sensor is between X and Y seconds, one demerit point is allocated; and when the continuous mouth-opening time detected by the mouth-opening detection sensor is Y seconds or longer, two demerit points are allocated (X<Y).

In the case where the selected medical training scenario is anesthesia and the target evaluation movement is injection, a criterion for evaluation shall be whether sensors for detecting the arrival of the upper and lower jawbone provided in the imitation patient body 2 have reacted or not. Specifically, when either or both of the sensors for detecting the arrival of the upper and lower jawbone have reacted, one demerit point is allocated; and when neither of the sensors for detecting the arrival of the upper or lower jawbone have reacted, one merit point is allocated.

In the case where the selected medical training scenario is anesthesia and the target evaluation movement is talking, criteria for evaluation shall be the presence or absence of talking, such as “Has the anesthesia started working?”, to the imitation patient body 2 and whether a detection sensor has reacted or not. Specifically, when the trainee's talking has been recognized through voice recognition by the voice processing unit 103 after a predetermined time has elapsed since the detection sensor detected the application of anesthesia, the imitation patient body 2 is recognized as having answered “Yes” and one merit point is allocated. When the trainee's talking has been recognized before a predetermined time has elapsed since the detection sensor detected the application of the anesthesia, the imitation patient body 2 is recognized as having answered “No” and three demerit points are allocated. When the trainee's talking has not been recognized due to a low voice or the like, one demerit point is allocated.

While the aforementioned criteria for evaluation includes whether a detection sensor provided in the imitation patient body 2 has reacted or not, the present invention is not limited thereto; and evaluations may be made by the speed of the reaction of a trainee to a certain action on the basis of a time base, or by comparing an exemplary reference value of a certain medical procedure and an actual value based on a previously created judgment scale of the values (time/quantity) for the apparatus or the like.

Note that the above-described evaluations are only examples; evaluation items with respect to which objective evaluations are made based on a predetermined criterion for evaluation may be set for each medical training scenario.

In addition, one considerable example of the results of measurement using external measurement equipment is the results obtained by measuring the shape of a cut tooth, for example, with three-dimensional measurement equipment and then determining whether the shape is a desired shape or not. As another alternative, the configuration may also be such that data that has been measured using external measurement equipment is transmitted to and evaluated by the operation unit 100.

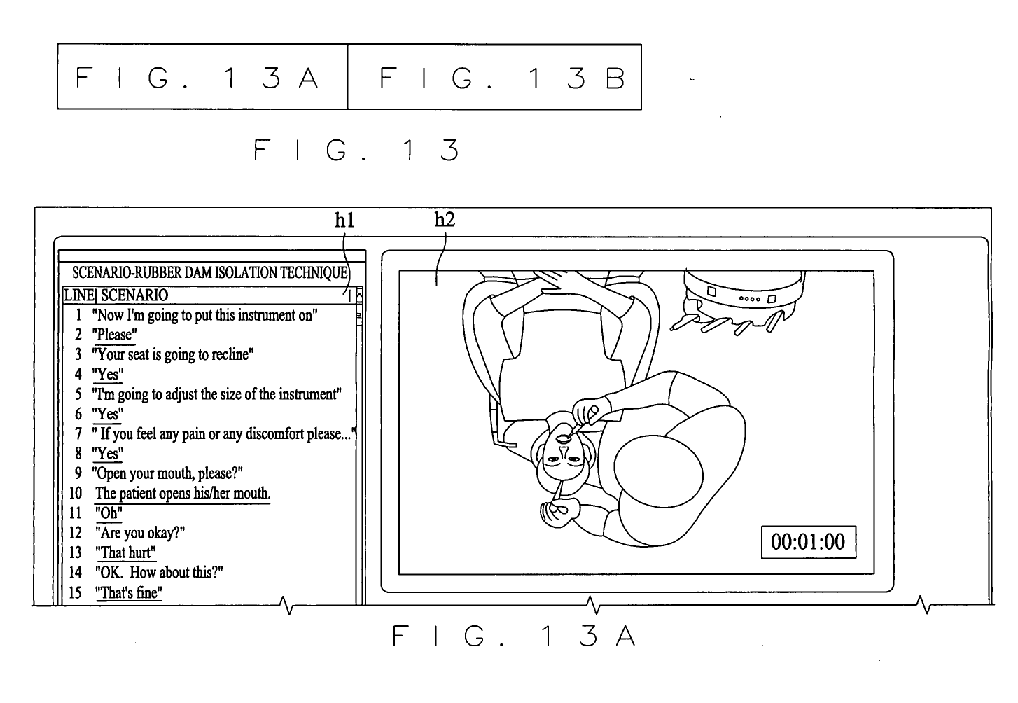

Next, in step S24, the evaluation results are subjected to predetermined statistical processing to be totaled in the operation unit 100. The total result obtained in step S24 is then displayed on the display unit 105 in step S25. FIG. 11 illustrates one example of a total result h5 that has been obtained by totaling the evaluation results. In the example of FIG. 11, the evaluation results obtained from a plurality of evaluators are totaled for each evaluation item and then a total score is calculated for each evaluation item. In addition, with the total result h5 in FIG. 11, the evaluation points have been calculated from the total score and a perfect score. Specifically, the evaluation points are defined as a value obtained by dividing a total score by a perfect score and multiplying the result by 100; if a total score in FIG. 11 is 151 out of a perfect score, 191, the evaluation points will be 79. Note that while, with the total result h5 in FIG. 11, a single evaluation point has been calculated from the combined evaluation results obtained from a plurality of evaluators, the present invention is not limited thereto; and the configuration may be such that evaluation points may be totaled for each evaluator. As another alternative, it is also possible to calculate an average value for each evaluation item from the evaluation results obtained from all trainees who have performed training under a specific medical training scenario. That is, the operation unit 100 performs statistical processing as an arithmetic operation of the evaluation results that have been input with the evaluation input unit 110. In the present preferred embodiment, a total score, evaluation points, and the like are calculated through the statistical processing performed on the evaluation results.

While the statistical processing illustrated in FIG. 11 is just a simple summation, the statistical processing according to the present invention is not limited thereto; for example, it is also possible to determine whether or not variations in a plurality of evaluation results are within a predetermined range. In the medical training apparatus, it is necessary to preclude invalid evaluations or evaluations that deviate noticeably from a standard deviation in order to obtain highly reliable training evaluations. Thus in the medical training apparatus according to the present embodiment, it is also possible to determine whether or not variations in the evaluation results are within a predetermined range and to give a notification to an evaluator who has run that operation of determination. Examples of such a case where the determination whether or not variations in a plurality of evaluation results are within a predetermined range is required are assumed to include the following cases. One example is the case where a plurality of evaluators evaluate the same training content. Another example is the case where a single evaluator evaluates the same training content a plurality of times and there are generally variations and no consistency in the evaluation results. Still another example is the case where a single evaluator evaluates the same training content a plurality of times and there are some extremes among the evaluation results.

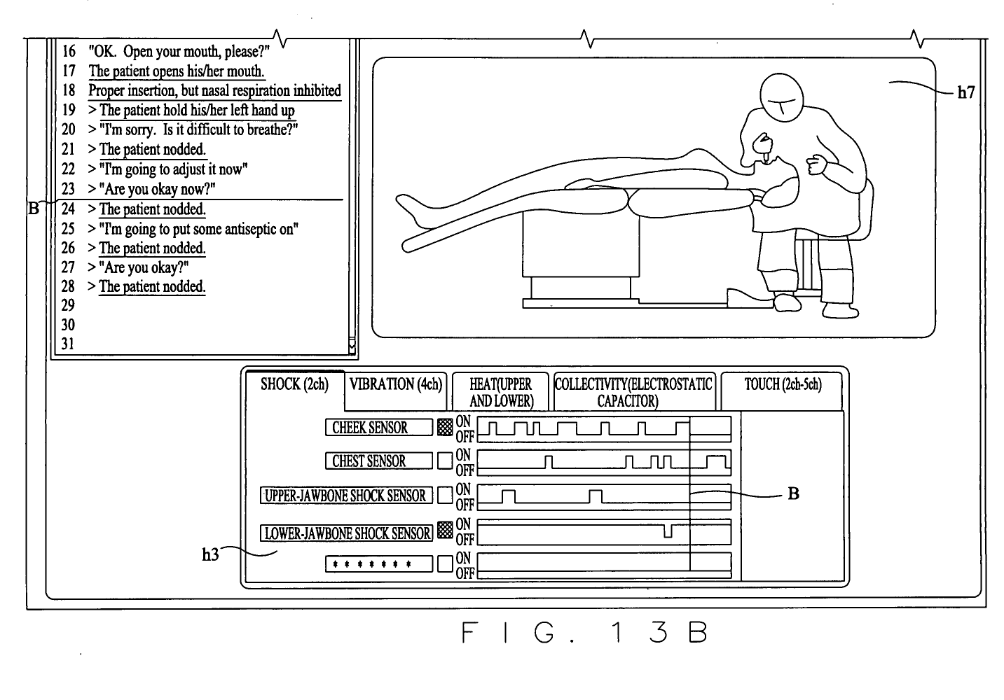

Next, in step S17, the training history that has been stored in association with the actual evaluation results in step S23 and the result that has been obtained by totaling the evaluation results in step S24 are associated with each other and stored in the storage unit 101 (the training-evaluation-information storage unit 101b). In step S18, it is possible to input an evaluation comment into the training history or each evaluation result or to display a current input comment or a previous input evaluation comment. Specifically, such input of an evaluation comment will be described with reference to FIG. 12. First, an evaluation result about which an evaluation comment is input is specified, and a comment input field h6 as illustrated in the upper part of FIG. 12 is displayed on the display unit 105 or the evaluation input unit 110 illustrated in FIG. 9. Then, an evaluation comment is input into the displayed comment input field h6 with a predetermined input unit (e.g., a keyboard, a stylus pen, a microphone). In the example of FIG. 12, an evaluator 1 inputs an evaluation comment stating “too far from the patient” about the evaluation result at the elapsed training time of “00:12:78.” Upon such input, the evaluation comment is displayed in the comment field of the screen h4, which displays evaluation results from evaluators, together with the name or any character string that specifies the input evaluator. Note that such an evaluation comment includes an objective and statistical comment that is selected and given from among previously prepared evaluation comments, according to the result of the analysis of all evaluation contents by the apparatus; and a subjective and arbitrary comment that is arbitrarily given by an evaluator such as an instructor. An evaluation comment that has been input from the comment input field h6 as illustrated in FIG. 12 is a comment that has been input by an evaluator.

Moreover, in step S19, a training history or the like that has been stored in step S17 is reproduced for the purpose of reviewing evaluation results, outputting evaluation results, or the like. By reproducing at least part of the training history in this way, a configuration that enables a trainee to perform self-learning training can be achieved. In addition, such a configuration may be used for any other purpose related to training; it may be used for a review of the contents of the evaluation, for example. While the output of evaluation results are implemented by the display unit 105, examples of the display unit 105 also include, in addition to the display unit 42 or 5 such as an LCD monitor illustrated in FIG. 1, a structure for outputting evaluation results to paper supplied from a printer or the like (not shown). By reviewing evaluation results, it is also possible to perform an operation of post-editing the input evaluation results (including an evaluation comment), such as addition, correction, and modification. The editing of evaluation results may be implemented with the operation unit 100, the input unit 102, or the like, and enables the apparatus to deal with an input error in the evaluation results, a human mistake, or misjudgment. Alternatively, if the evaluation input unit 110 is equipped with an editing operation medium or mechanism, it may be used in such an editing operation.

As described above, the medical training apparatus according to the present preferred embodiment enables an evaluator to perform evaluation training, utilizing the evaluation mode of reproducing an already stored training history or the like. When an evaluator performs such evaluation training, i.e., when “Evaluation Mode,” “Reproduction,” and “Manual” have been selected from the mode selection menu in FIG. 5, preparations for evaluation training for an evaluator are made in step S30. Then, in step S31, a training history with which evaluation training is performed is reproduced, and an evaluator inputs his or her new evaluation result while referring to the training history. Then, in step S19, the new evaluation result that has been input in step S31 and the past evaluation result that has been stored in association with the reproduced training history are compared and reviewed for the evaluation training.

### Second Preferred Embodiment

In the medical training apparatus according to the first preferred embodiment, an image (cf. FIG. 10) that has been captured from above the imitation patient body 2 by the image pickup camera 64 provided on the arm 62 illustrated in FIG. 1 is displayed on the display unit 105. The medical training apparatus according to the first preferred embodiment then stores that image as a training history.

However, there are limitations for an evaluator in evaluating training on the basis of a training history that has stored only images of the imitation patient body 2 captured from above. In other words, in some cases there may be a portion that cannot be evaluated with only images of the imitation patient body 2 that have been captured from above.

Thus, the medical training apparatus according to the present preferred embodiment is provided with, in addition to a camera that captures an image of the imitation patient body 2 from above, at least one more camera that captures an image from a different angle. The medical training apparatus according to the present preferred embodiment stores an image of the imitation patient body 2 captured from above and an image thereof captured from a different angle as a training history. Each camera for use in image capturing may preferably have wide-angle and zooming capabilities.

More specifically, the medical training apparatus according to the present preferred embodiment provides a display screen as illustrated in FIG. 13, for example. The display screen illustrated in FIG. 13 includes a screen h2 that displays an image captured by the image pickup camera 64 (an image of the imitation patient body 2 captured from above), a screen h7 that displays an image of the imitation patient body 2 captured from the side, a screen h1 that displays a medical training scenario, and a screen h3 that displays the output of each sensor provided in the imitation patient body 2. The medical training scenario illustrated in FIG. 4B is displayed on the screen h1 for displaying a medical training scenario. On the screen h3 for displaying the output of each sensor, the outputs of a shock sensor, a vibration sensor, a thermal sensor, a continuity (electrostatic capacitance) sensor, and a touch sensor that are provided in the imitation patient body 2 are displayed. Note that the medical training apparatus according to the present preferred embodiment is similar to the medical training apparatus according to the first preferred embodiment, except in that it displays and stores images that have been captured from different angles as illustrated in FIG. 13, and its detailed description is thus omitted herein.

As described above, the medical training apparatus according to the present preferred embodiment enables a proper evaluation of a training session by also using an image captured from a different angle to observe an evaluating portion that cannot be checked with only an image of the imitation patient body 2 captured from above. In other words, this apparatus provides a situation close to a situation where a training session is performed in front of an evaluator, so that an evaluator can make a better evaluation while observing images captured from a plurality of angles. This may make it possible to separate a training session and an evaluator's evaluation of the training session both temporally and spatially, thereby increasing environmental flexibility when an evaluator performs training evaluations.

While, in the example of FIG. 13, the images captured from two different angles are displayed at the same time, they are not necessarily displayed simultaneously; the configuration may be such that the angle of a displayed image may be changed by pressing a camera-angle control button, as illustrated in the evaluation input unit 110 of FIG. 9.

While the first and second preferred embodiments described above explained the case of performing training using the imitation patient body 2 as a patient, the present invention is not limited thereto; for example, a real person such as a real consulting patient or another trainee may be used as a patient. However, if a real person is used as a patient, the signals of various sensors provided in the imitation patient body 2 cannot be stored as a training history. In addition, if the medical training apparatus according to the present invention is adopted in the case of using an actual person as a patient, this apparatus can also be used as an evaluation apparatus for evaluating an actual medical procedure.

Specifically, when an actual medical procedure is performed on a real patient, the medical training apparatus according to the present invention enables an evaluator to determine whether or not the medical procedure has been conducted according to a clinical procedure that corresponds to a medical training scenario. Here, the contents of a clinical procedure are basically equivalent to a medical training scenario; the difference is only in that the clinical procedure is not so minutely defined as compared to the training scenario. Also, there are basically not so many differences between the evaluation items used for training and the evaluation items used for an actual medical procedure. Regarding stored history information, the training content is simply replaced by content based on an actual medical procedure. Thus, the medical training apparatus according to the present invention is also capable of judging and evaluating information obtained from an actual medical procedure, depending on the contents that can be visually checked by an evaluator or depending on items such as talking that can be assessed using a voice processing unit or any other item that can be assessed with the sensors provided on an examination table, the medical instruments, and the like. Note that, if a common examination table that may be used for an actual medical procedure is employed in the medical training apparatus according to the present invention, the apparatus can more easily be used to evaluate a medical procedure.

In the medical training apparatus M according to the present invention, the target evaluation movements include “talking” and some exemplary examples described above disclose the case for evaluating a trainee talking to a patient (the imitation patient body 2); however, the evaluation of “talking” is not limited to such trainee-led verbal communication. Alternatively, the trainee's actions in dealing with patient-led verbal communication (verbal communication under the initiative of the imitation patient body 2) may be evaluated. When the evaluation of “talking” is performed with the medical training apparatus M, evaluation targets may be the voluntary action of a trainee in talking to a patient (the imitation patient body 2) and a trainee's actions in dealing with a patient's (imitation patient body 2) voluntary action of talking to the trainee. For example, when the imitation patient body 2 talks to a trainee during training, for example, asking questions, expressing his or her own wishes, or discussing something such as “Are you going to cut a tooth?”, “Is it going to hurt?”, “How much longer will it take?”, “Can I rinse my mouth?”, “Doctor, I'm not feeling very well”, evaluations can be performed based on the trainee's reaction to such a situation, such as how the trainee has answered to the patient or what action the trainee took. Since such an unexpected situation for a trainee is naturally expected to occur during an actual medical procedure, this apparatus configuration is good for effective training. Note that such a matter as a patient's (the imitation patient body 2) voluntary verbal communication may be included in a medical training scenario in advance; or instead of being included in a medical training scenario, it may be added by a third party operating the operation input unit 102 (e.g., the operation unit 43 illustrated in FIG. 1 or a PC microphone not shown). Even with a medical training apparatus that is not equipped with an imitation patient body, it is possible to set such a situation as a patient's voluntary verbal communication into a medical training scenario by, for example, outputting character data on the screen of a display unit or outputting voice data from a voice output unit.

Note that, since the medical training apparatus M according to the present invention is configured to have various capabilities as described above, it may preferably have a demonstration capability of giving a user (e.g., a trainee, an evaluator, or a third party who exercises control) explanations of the configuration of a product that include an explanation of the specification of each component and an explanation of the movements of the imitation patient body 2. By using image information on the display screen and voice information such as narration and by actually reproducing the movements of the imitation patient body 2, the demonstration capability provides guidance on, for example, information about the specification of each unit of the apparatus or usage of each unit, such as the function of a GUI displayed on the display unit 42 in a PC, a method for using a medical care unit that includes the instrument table 1 and the like, the specification of and the method for handling each component of the imitation patient body 2, countermeasures using an emergency shutdown switch or the like in an emergency, and the method for operating the evaluation input unit 44. In addition to this, in order to show how a GUI on the screen of the display unit 42, the imitation patient body 2, and the like will operate in an actual training situation, the actions of the training apparatus M can be demonstrated to a user by performing simulated training that has been recorded in the storage unit 101 or the like. The medical training apparatus M with such a demonstration capability as described above enables a user such as a trainee, an evaluator, or a third party who exercises control to use this apparatus with a thorough understanding of the apparatus's capabilities. This is desirable because a user who uses this apparatus for training can perform training more effectively while making the most of the apparatus's high capabilities.

While the preferred embodiments have been described so far, the present invention is not limited to the preferred embodiments described above and various variations are possible. For example, the above-described preferred embodiments have described that the operation unit 100 that operates according to a program can be implemented using software. However, some or all of the functions of those functional blocks may be configured with a dedicated logic circuit and can be implemented using hardware.

Moreover, the steps described in the above-described preferred embodiments are only illustrative and not limited to the order or the contents described herein. In other words, the order or the like may be changed as appropriate if similar effects can be achieved.

While the invention has been shown and described in detail, the foregoing description is in all aspects illustrative and not restrictive. It is therefore understood that numerous modifications and variations can be devised without departing from the scope of the invention.

What is claimed is:

1. A medical training apparatus comprising:
a training-history-information storage unit that stores history information about a training session that has been performed under a preset medical training scenario;
an evaluation input unit that inputs an evaluation result for either said training session or said history information that has been stored in said training-history-information storage unit, with respect to a predetermined evaluation item for each predetermined matter;
an operation unit that performs an arithmetic operation on said evaluation result that has been input with said evaluation input unit; and
a training-evaluation-information storage unit that stores a result of said operation unit and said evaluation result in association with said history information.

2. The medical training apparatus according to claim 1, further comprising:
a display unit that displays at least any one of said history information, the result of said operation unit, and said evaluation result.

3. The medical training apparatus according to claim 1, further comprising:
an image capturing unit that captures an image of said training session;
wherein said training-history-information storage unit stores said history information that includes an image of said training session that has been captured by said image capturing unit.

4. The medical training apparatus according to claim 3, wherein
said image capturing unit is configured so as to be capable of capturing images of said training session from a plurality of angles.

5. The medical training apparatus according to claim 1, further comprising:
an imitation patient body including a drive unit that produces motion of at least a mouth and eyes, and a detection unit provided at a tooth in an oral cavity or a jaw;
wherein said training-history-information storage unit stores said history information that includes a drive history of said drive unit and a detection history of said detection unit.

6. The medical training apparatus according to claim 5, wherein
said imitation patient body is configured so as to produce a facial expression or movement depending on said evaluation result.

7. The medical training apparatus according to claim 5, wherein
said imitation patient body is configured so as to vary a facial expression or movement by driving of said drive unit with an input unit.

8. The medical training apparatus according to claim 1, wherein
said evaluation input unit is configured so as to be capable of inputting an evaluation result with respect to said predetermined evaluation item by selecting said predetermined evaluation item from among a plurality of preset options.

9. The medical training apparatus according to claim 1, wherein
said evaluation input unit is configured so as to be capable of inputting a comment for each evaluation result with respect to said predetermined evaluation item.

10. The medical training apparatus according to claim 1, wherein
said evaluation input unit includes a plurality of evaluation input units; and
said operation unit is configured so as to perform predetermined statistical processing on a plurality of evaluation results that have been input with each of Said evaluation input units.

11. The medical training apparatus according to claim 10, wherein
said operation unit is configured so as to perform said predetermined statistical processing that includes a process for determining whether or not variations in said plurality of evaluation results are within a predetermined range.

12. The medical training apparatus according to claim 1, further comprising:
a measurement equipment evaluation input unit that inputs a measurement result based on said training session;
wherein said training-evaluation-information storage unit stores said evaluation result that includes said measurement result for said measurement equipment evaluation input unit in association with said history information.

13. The medical training apparatus according to claim 1, further comprising:
a voice processing unit that processes a voice based on said training session and supplies information about said voice that has been processed to either said training-history-information storage unit or said operation unit.

14. The medical training apparatus according to claim 1, comprising a configuration that can be used for self-learning by a trainee by calling up at least any one or more of said evaluation result, the result of said operation unit, and said history information that has been associated with either said evaluation result or the result of said operation unit.

15. The medical training apparatus according to claim 1, comprising a configuration that enables training of an evaluator by calling up at least any one or more of said evaluation result, the result of said operation unit, and said history information that has been associated with either said evaluation result or the result of said operation unit and then inputting a new evaluation result with said evaluation input unit.
